(19) United States
(12) Patent Application Publication
(10) Pub. No.: US 2025/0334994 A1
(43) Pub. Date: Oct. 30, 2025

(54) INTEGRATED PLATFORM FOR ON-CHIP SPATIAL ANALOG OPTICAL COMPUTING

(71) Applicant: UNM RAINFOREST INNOVATIONS, Albuquerque, NM (US)

(72) Inventor: Francesca CAVALLO, Albuquerque, NM (US)

(73) Assignee: UNM RAINFOREST INNOVATIONS, Albuquerque, NM (US)

(21) Appl. No.: 19/184,171

(22) Filed: Apr. 21, 2025

Related U.S. Application Data
(60) Provisional application No. 63/638,166, filed on Apr. 24, 2024.

(51) Int. Cl. G06E 3/00; G02F 1/29; G02F 1/295

(52) U.S. Cl. CPC G06E 3/005; G02F 1/294; G02F 1/295; G02F 2202/10

(57) ABSTRACT

An integrated computing platform for performing spatial analog optical computing on a chip and a method for fabricating an integrated computing platform is disclosed. The computing platform includes a semiconductor substrate with a backgate electrode on a bottom side of the substrate. The integrated computing platform includes one or more graded index media sections on a top surface of the substrate which may include a grooved recess, and a meta-transmit array (MTA) on the top side of the substrate and adjacent to the graded index media sections. The method for fabricating the integrated computing platform includes etching a surface of a semiconductor substrate to create a plurality of sharp v-shaped grooves in a surface of the semiconductor substrate, creating a plurality of paraboloid-shaped grooves in the surface of the semiconductor substrate and filling the plurality of paraboloid-shaped grooves with a dielectric material.

### REFERENCE TO RELATED APPLICATIONS

This application claims priority to U.S. 63/638,166, filed on Apr. 24, 2024. The 63/638,166 is hereby incorporated by reference in its entirety.

### TECHNICAL FIELD

The present teachings relate generally to spatial analog computing on a chip (SAOC) and, more particularly, to integrated platforms and fabrication thereof to perform spatial analog computing on a chip (SAOC).

### BACKGROUND

Analog Optical Computing (AOC) directly manipulates the physical features of electromagnetic waves, for example, its continuous amplitude and phase, either spatially or temporally to perform computing operations with potentially nearly zero power consumption. Wave-based computation has been demonstrated on the optical table via customized setups based on bulky optical components. The complex structure and form factor of these systems prevent their integration with nanophotonic circuits and cause significant constraints such as spherical aberration and diffraction limit. Several conceptual designs to perform wave-based computation on integrated chips have also been reported. However, the practical realization of the proposed building blocks while maintaining an acceptable level of integration and the required tolerance remains a challenge to be mastered.

From a technology standpoint, the fabrication of inhomogeneous and anisotropic materials to manipulate electromagnetic waves on a chip has shown promising results. However, the achievable length scales, interface/surface quality, geometries, and materials combinations are far from providing the required flexibility in inhomogeneity and anisotropy of relevant materials' attributes, such as conductivity and permittivity. Furthermore, there is limited to no understanding of any change in the physical and chemical structure of the material, and its boundary with the external environment will affect the functionality of an integrated system to perform AOC.

Therefore, it is desirable to fabricate smaller scale devices capable of performing spatial analog optical computing with faster operation and lower power consumption as compared to traditional computing methods or devices.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An integrated computing platform for performing spatial analog optical computing on a chip is disclosed. The integrated computing platform also includes a semiconductor substrate. The integrated computing platform also includes a backgate electrode on a bottom side of the semiconductor substrate. The integrated computing platform also includes one or more graded index media sections on a top surface of the semiconductor substrate may include a grooved recess. The integrated computing platform also includes a meta-transmit array (MTA) on the top side of the semiconductor substrate and adjacent to the one or more graded index media sections. Implementations of the integrated computing platform for performing spatial analog optical computing on a chip can include where the semiconductor substrate includes germanium. The semiconductor substrate can include a dielectric layer disposed in at least a portion of the grooved recess. One or more graded index media sections can include a graphene layer on the top or front surface of the dielectric layer. The one or more graded index media sections are configured to perform a fourier transform (FT) of a wave. The one or more graded index media sections further may include a parabolic profile may include a plurality of parabolic contours in at least one spatial direction. The MTA can further include a top surface layer including graphene. The backgate electrode on the bottom or back surface of the semiconductor substrate may include a metal.

A method for fabricating a platform for performing spatial analog optical computing on a chip is disclosed. The method includes etching a surface of a semiconductor substrate anisotropically to create a plurality of sharp v-shaped grooves in a surface of the semiconductor substrate, creating a plurality of paraboloid-shaped grooves in the surface of the semiconductor substrate by isotropic etching in water to smooth sharp tips and walls of the v-shaped grooves, filling the plurality of paraboloid-shaped grooves with a dielectric material. The method also includes transferring a graphene sheet from a growth substrate onto the surface of the semiconductor substrate. Implementations of the method for fabricating a platform for performing spatial analog optical computing on a chip can include where the semiconductor substrate may include a (001) germanium. The dielectric material can include a polymer. The polymer can include an epoxy. The method for fabricating a platform for performing spatial analog optical computing on a chip may include depositing the dielectric material via spin coating a polymer to fill the plurality of paraboloid-shaped grooves. The growth substrate can include a copper foil. The method for fabricating a platform for performing spatial analog optical computing on a chip may include using a polymer-assisted process to transfer the graphene sheet onto the surface of the semiconductor substrate. The method for fabricating a platform for performing spatial analog optical computing on a chip may include metalizing a back surface of the Ge substrate by physical vapor deposition to create a backgate electrode.

An integrated computing platform is disclosed. The integrated computing platform includes a meta-transmit array (MTA) array including a patterned germanium substrate. The integrated computing platform also includes a graded index (GRIN) lens which may include a parabolic profile on the patterned germanium substrate. The integrated computing platform also includes a backgate electrode on a back side of the patterned germanium substrate. Implementations of the integrated computing platform can include where the patterned germanium substrate may further include a dielectric layer disposed into the parabolic profile of the graded index (GRIN) lens. The backgate electrode can include a metal. The integrated computing platform can include a control circuit connected to the backgate and configured to control a surface conductivity in the GRIN lenses. Implementations of the described techniques may include hardware, a method or process, or computer software on a computer-accessible medium.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A and 1B are schematic illustrations of an integrated system to perform spatial analog computing on a chip (SAOC) including block diagrams of a system to perform AOC in the spatial Fourier domain (FIG. 1A) and a schematic illustration of the realization of the system in FIG. 1A based on graphene/Ge (Gr/Ge), respectively, in accordance with the present disclosure.

FIGS. 2A-2F are illustrative renderings of the fabrication process of a graded index (GRIN) lens based on graphene/Ge, in accordance with the present disclosure.

FIGS. 3A-3F are schematic illustrations of the fabrication process of nanoscale Ge gratings with tunable amplitude-to-period ratio, in accordance with the present disclosure.

FIGS. 4A-4D are schematic illustrations of the fabrication process of a meta-transmit array (MTA) based on transfer of CVD graphene to a Ge linear grating, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides an integrated platform for spatial analog optical computing (SAOC) based on graphene/Ge (Gr/Ge) that presents an alternative approach to performing wave-based computations on an integrated chip. By leveraging the properties of graphene plasmon waves and utilizing highly confined surface waves on graphene, the design and methods of fabrication herein can enable the minimization of absorption loss while enabling compatibility with CMOS technology. The platform integrates multiple graded index (GRIN) media that perform the Fourier transform (FT) of a wave propagating through the graded index (GRIN) media. By further incorporating a meta-transmit array (MTA), the design allows for efficient computation in the spatial Fourier domain.

The fabrication process utilizes a graphene/Ge platform that involves creating GRIN lenses and MTAs using graphene on a Ge grating, also referred to as a quilt substrate. The GRIN media can be implemented as a metal-dielectric-graphene structure, where the dielectric has a paraboloid shape. This design allows for a continuous and parabolic variation of conductivity and permittivity by applying a spatially uniform back-gate voltage to achieve modulation of surface conductivity.

The use of graphene plasmon wave-based computation offers several advantages over other methods for SAOC, including minimizing absorption loss and potentially enabling faster computations due to the highly confined surface waves on graphene. Additionally, the choice of Ge substrate impacts the performance and feasibility of the integrated platform by providing excellent electronic and structural properties that are compatible with CMOS technology. This makes it easier to fabricate and integrate the GRIN lenses, MTA array, and backgate voltage into a single chip.

The integrated SAOC system described herein can serve for applications in optical signal processing, imaging, and communication systems that require high-speed and low-power computation. However, achieving an acceptable level of integration and tolerance while maintaining the required flexibility in anisotropy of relevant materials and their inherent attributes remains a challenge to be mastered in the prior art. The present disclosure provides improvements to the design of the GRIN lenses, MTA array, and backgate voltage which further includes optimizing the shape and size of the paraboloid dielectric insert for improved performance, adjusting the thickness and uniformity of the backgate voltage for better conductivity modulation, and use of alternative materials or substrates with enhanced properties.

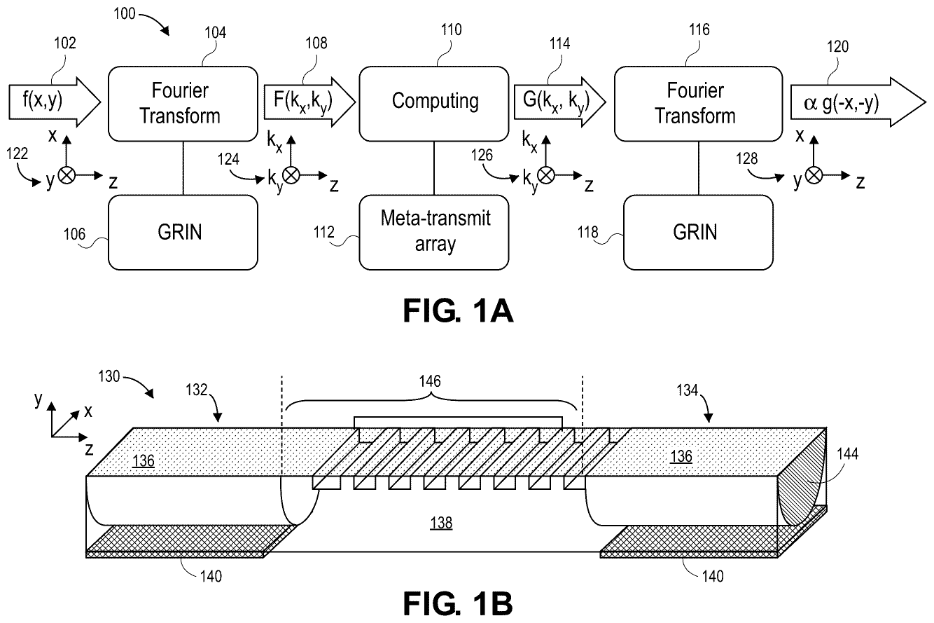

FIGS. 1A and 1B are schematic illustrations of an integrated system to perform spatial analog computing on a chip (SAOC) in the spatial Fourier domain (FIG. 1A) and a schematic illustration of the realization of the system in FIG. 1B based on graphene/Ge (Gr/Ge), respectively, in accordance with the present disclosure. The present disclosure provides an integrated platform to perform SAOC. In the design, a computing block 110 is sandwiched between two components that perform a Fourier transform (FT) 104 and 116 of a wave that propagates through them. In FIG. 1A, f(x,y) 102 is the transverse electric field distribution of the incident wave, F(kₓ,k_{y}) 108 is the FT of the incident wave, G(kₓ,k_{y}) 114 is equal to H(kₓ,k_{y})F(kₓ,k_{y}) and is the result of the desired computation in the spatial Fourier domain, and g(−x,−y) 120 is the mirror image of g (x,y) or the IFT of G(kₓ,k_{y}) 114. Following the design in FIG. 1A, the platform 100 integrates two graded index (GRIN) media 106, 118 that will serve as the FT 104 and 116 blocks with a meta-transmit array (MTA) 112. The design leverages graphene plasmon wave-based computation. Using highly confined surface waves on graphene will potentially minimize absorption loss. The choice of the Ge substrate is motivated by the excellent electronic and structural properties of the graphene/Ge combination and its compatibility with CMOS technology. The reference cartesian systems of coordinates in the are shown in real space 122,128 and Fourier space 126, 128. The integrated system 130 to realize SAOC is schematically illustrated in FIG. 1B. The GRIN media 132, 134 are implemented by a metal-dielectric-graphene structure where the dielectric 144 has a paraboloid shape. Graphene 136 on a Ge grating (or on a “quilt substrate”) serves as the MTA 146. The underlying operating principle of the three blocks relies on the modulation of surface conductivity by using either a backgate 140 (for the GRIN lenses) or graphene interactions with different environments, such as air and a Ge substrate 138. The backgate 140 includes a metal or a metal alloy, such as Ti/Au, Cr/Au, and NiGeAu. It should be noted that the backgate 140 electrode is only positioned under the GRIN 132, 134 locations and not positioned under the MTA 146.

The integrated computing platform of the present disclosure includes a meta-transmit array (MTA) array comprising a patterned germanium substrate, a graded index (GRIN) lens comprising a parabolic profile on the patterned germanium substrate, and a backgate electrode, which can include one or more metals or alloys, on a back side of the patterned germanium substrate. The patterned germanium substrate further includes a dielectric layer disposed into the parabolic profile of the graded index (GRIN) lens. The integrated computing platform can further include a control circuit connected to the backgate and configured to control surface conductivity in the GRIN lenses.

In more specific examples of the integrated computing platform for performing spatial analog optical computing on a chip of the present teachings includes a semiconductor substrate, a backgate electrode on the bottom side or back surface of the semiconductor substrate, one or more graded index media sections on a top side, top surface, or front surface of the semiconductor substrate comprising a grooved recess, and a meta-transmit array (MTA) on the top side of the semiconductor substrate and adjacent to the one or more graded index media sections. In specific examples, the semiconductor substrate includes germanium and may further include a dielectric layer disposed in at least a portion of the grooved recess or a graphene layer on the top surface of the dielectric layer within one or more graded index media sections. The one or more graded index media sections are configured to perform a Fourier transform (FT) of a wave. The one or more graded index media sections, as shown, can include a parabolic profile comprising a plurality of parabolic contours in at least one spatial direction, while the MTA further includes a top surface layer comprising graphene.

A graded index (GRIN) is a material or a structure with a permeability μ₀ and a parabolically varying permittivity. A GRIN performs the FT of a wave that propagates through it. A meta-transmit array (MTA) comprises multiple metasurfaces formed by an array of plasmonic or metallic elements alternating with dielectric elements. The MTA can generate a variety of phase and amplitude profiles for a wave that travels through it. The geometry and spatial arrangement of the elements in an MTA are defined by the wavelength of the electromagnetic radiation selected to interact with the structure as well as the target phase and amplitude of the wave as it exits the MTA. In turn, the target phase and amplitude of the wave as it exits the MTA depend on the type of computation to be performed (e.g., derivate or convolution).

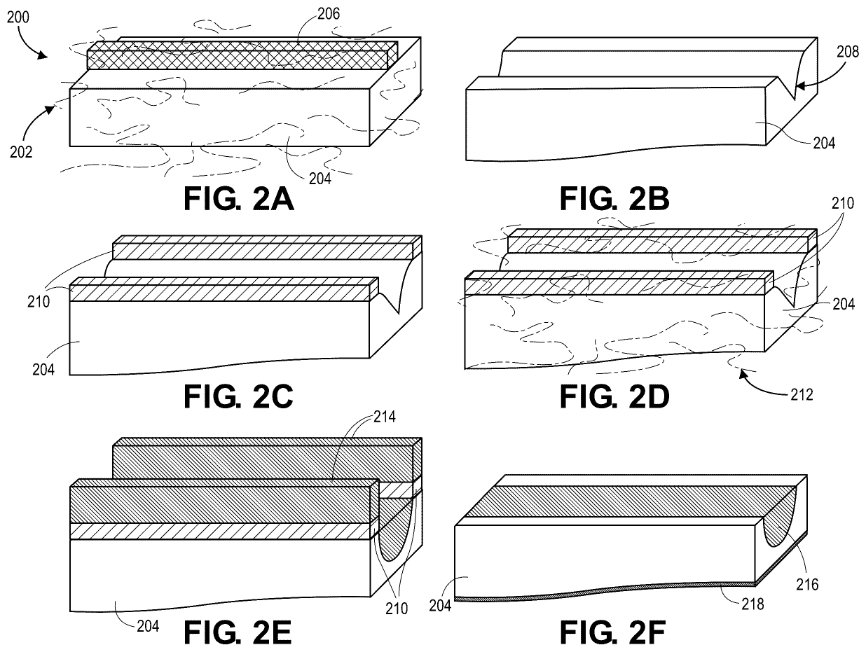

FIGS. 2A-2F are illustrative renderings of the fabrication process of a graded index (GRIN) lens based on graphene/Ge, in accordance with the present disclosure. The fabrication process 200 of the graded index (GRIN) lens begins in a water-based media 202 with a germanium (Ge) substrate 204 having a platinum or silver 206 surface coating. This metal is subsequently etched to form a v-groove 208, as shown in FIG. 2B. Masking layer 210 elements are applied onto a surface of the Ge substrate 204 on either edge of the v-groove 208 (FIG. 2C). The anisotropic etching of the Ge substrate to create v-grooves 208 is followed by isotropic etching in water media 212 to smooth the sharp edges of the v-grooves 208, as shown in FIG. 2D.; dielectric 214; graphene-coated dielectric 216; a back gate electrode 218, as shown in FIG. 2E, a dielectric 214 insert is then fabricated in the Ge substrate 204, and graphene is transferred onto the inhomogeneous substrate using a polymer-assisted process to provide a graphene-coated dielectric 216. Finally, the back surface of the Ge substrate is metalized using physical vapor deposition to create a backgate electrode (FIG. 2F).

During fabrication and characterization of Gr/Ge-based GRIN lenses of the present design, a GRIN lens is obtained by creating a parabolic profile of conductivity across a graphene sheet by a non-uniform applied backgate voltage. This spatial variation of the electric field is achieved by using an uneven thickness of a gate dielectric. By designing the dielectric in the shape of a paraboloid, one can obtain a continuous and parabolic variation of conductivity and permittivity by applying a spatially uniform back-gate voltage. This approach has the advantage of minimizing reflections as there are no sharp changes in the conductivity. The present design for GRIN lenses is based on a metalized Ge substrate that includes a dielectric cut-out shaped like a paraboloid. The graphene is bonded onto the inhomogeneous substrate in this structure (as shown in FIGS. 2A-2F). The process begins with the fabrication of the dielectric insert in the Ge substrate. For this purpose, anisotropic etching of the (001) Ge substrate is performed to obtain v-grooves. Isotropic etching in water is then performed to smooth the sharp tip and the walls of the v-grooves to obtain a paraboloid. The trench in the Ge may be then filled with a dielectric. The dielectric can be deposited via physical vapor deposition (PVD) or CVD, or it can be spun on, as in the case of SU-8. SU-8 is composed of a bisphenol A Novolac epoxy that is dissolved in an organic solvent (for example, gamma-butyrolactone GBL or cyclopentanone) and up to 10 wt % of mixed triarylsulfonium/hexafluoroantimonate salt as the photoacid generator.

An integrated platform for SAOC based on Gr/Ge can be fabricated by the transfer of a graphene nanosheet on an appropriately patterned bulk or thin-film Ge substrate to create GRIN lenses and MTAs. The processes can be implemented in the same Ge substrate using the same graphene nanosheet. The fabrication process for Gr/Ge-based GRIN lenses incorporates the creation of a parabolic profile of conductivity across a graphene sheet with the application of a non-uniform backgate voltage.

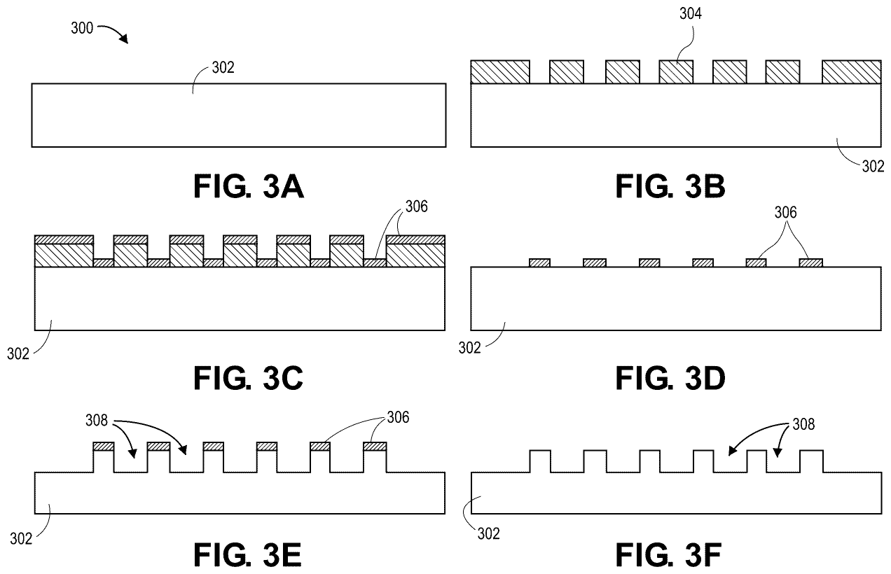

FIGS. 3A-3F are schematic illustrations of the fabrication process of nanoscale Ge gratings with tunable amplitude-to-period ratio, in accordance with the present disclosure. The graphene/Ge meta-transmit array (MTA) is a component of the integrated platform for SAOC based on Gr/Ge, that enables efficient coupling between the propagating wave and the computing blocks. The MTA fabrication process 300 involves transferring one-dimensional Ge gratings 308 onto an intrinsic Ge (001) substrate 302 via dry etching over an e-beam resist layer material 304 to achieve using a Cr or Ni hard mask 306. The hard mask 306 is fabricated through e-beam (or interference) lithography, metal deposition, and lift-off processes. This results in a high-resolution pattern of nanoscale periods and shapes that can be tailored to specific applications.

Once the hard mask 306 is patterned, the intrinsic Ge substrate 302 is etched using dry etching techniques to create the desired grating structure. The etching process can be performed using techniques such as reactive ion etching (RIE) or deep reactive ion etching (DRIE), which allow for precise control over the grating period, depth, and shape. After etching, the hard mask is removed through lift-off, leaving behind the patterned Ge gratings 308. The width, depth, and length of grooves are broadly fabricated to have final dimensions on a micron scale, including between a few to several 100 s micrometers. Simulations would be needed to further define. The thickness of the dielectric layers will match the variable depth of the grooved recess.

The characterization of GRIN lenses as described herein can involve assessing their optical and electrical properties to ensure optimal performance. This can include measuring the refractive index profile, the thickness of the dielectric insert, and the conductivity modulation across the graphene sheet. Additionally, the polarization-sensitive loss and the extinction ratio are also evaluated to determine the effectiveness of the GRIN lens in minimizing absorption loss (FIGS. 3A-3F).

In a proposed characterization experiment, a DC and spatially uniform biasing voltage will be applied between the gate electrode and graphene to create a parabolic profile of the conductivity and permittivity in the nanosheet. Surface waves can be excited using a vector-network analyzer connected to a cascade microprobe. An antenna placed on a motorized stage Can be used to scan the sample to probe the instantaneous magnitude of the electric field in the plane through measurements of the magnitude profiles of the electric field.

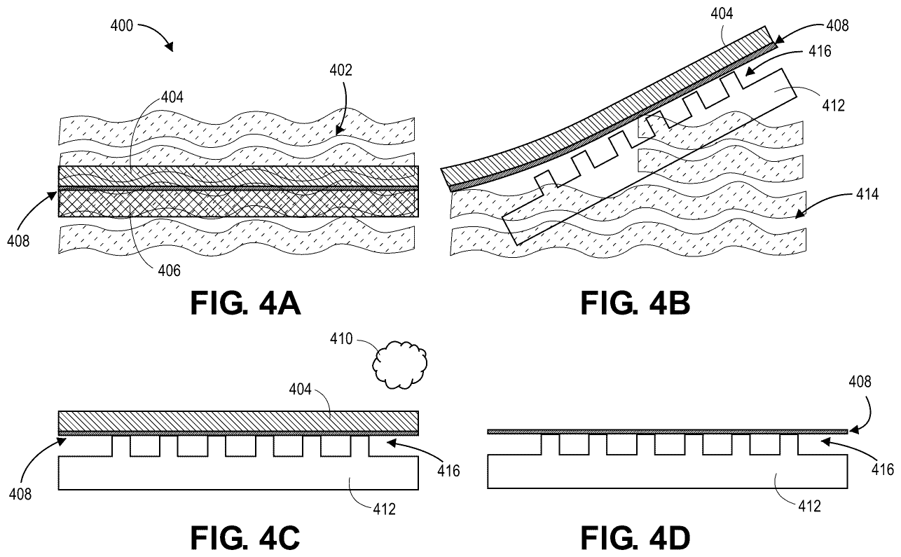

FIGS. 4A-4D are schematic illustrations of the fabrication process of a meta-transmit array (MTA) based on the transfer of CVD graphene to a Ge linear grating, in accordance with the present disclosure. In a final step, graphene is transferred from its growth substrate (i.e., copper foil) onto the inhomogeneous substrate using a polymer-assisted process, and the back surface of the Ge substrate is metalized by physical vapor deposition to create a back-gate electrode. In the meta-transmit array (MTA) fabrication process 400 of graphene/Ge meta-transmit array, the MTA array is fabricated by polymer-assisted transfer of graphene on a patterned Ge substrate 412. One-dimensional Ge gratings 416 are transferred to an intrinsic Ge (001) substrate 412 via dry etching using a Cr or a Ni hard mask, as shown in regard to FIGS. 3A-3F. The hard mask is fabricated by e-beam (or interference) lithography, metal deposition, and lift-off. Nanoscale pitch (L) and amplitudes (A) in a varying A/L ratio between 1:1 and 10:1 can be obtained using this process. A varying pitch and A/L ratio can also be realized. Graphene 408 is then transferred onto the grating 416 using a polymer support 404 with a thickness ranging from several hundred nanometers to a few micrometers, as further detailed in regard to FIGS. 4A-4D. The polymer 404 is selected among e-beam and optical resists that exhibit a high selectivity in FeCl₃/HCl solution 402 with respect to the growth substrate, such as a foil made of copper (Cu) 406, then the graphene 408 is transferred in a water media 414 (FIG. 4A and 4B). By removing the polymer 404 using a dry process such as vacuum annealing in an argon (Ar) atmosphere 410 (FIG. 4C), the process 400 circumvents the effect of capillary forces that may lead to a conformal contact of graphene 408 with the Ge grating 416. This provides the general structure shown in FIG. 4D. Next, metalization of the back surface of the Ge substrate is performed using physical vapor deposition (PVD) or other suitable techniques to create a back-gate electrode for controlling the conductivity variations in the GRIN lenses.

The overall method for fabricating a platform for performing spatial analog optical computing on a chip, includes the steps of etching a surface of a semiconductor substrate anisotropically to create a plurality of sharp v-shaped grooves in a surface of the semiconductor substrate, creating a plurality of paraboloid-shaped grooves in the surface of the semiconductor substrate by isotropic etching in water to smooth sharp tips and walls of the v-shaped grooves, filling the plurality of paraboloid-shaped grooves with a dielectric material, and transferring a graphene sheet from a growth substrate onto the surface of the semiconductor substrate.

The semiconductor substrate can include germanium, silicon, III-V compounds, and SiC substrates. In examples, the dielectric material comprises a polymer, such as epoxy, spin-on-glass (SOG), or parylene. The dielectric material can be applied by spin coating to fill the plurality of paraboloid-shaped grooves.

The present teachings leverage recent developments in the field as it relies on the idea of computational metamaterials, and the methods and devices described herein provide a practical realization of conceptual AOC designs on a CMOS-compatible material platform. The Gr/Ge platform has the potential to provide length scales, interface/surface quality, and geometries that fulfill the required flexibility in anisotropy of relevant material attributes such as conductivity and permittivity.

Additional methods of operation of the CMOS-compatible material platform can employ modulating surface conductivity in the GRIN lenses, for example, by applying a non-uniform backgate voltage to the backgate electrode to provide a parabolic electrical conductivity profile across the graphene sheet. Implementations include GRIN lenses created by applying non- uniform backgate voltage to create a parabolic profile of conductivity across a graphene sheet. where the MTA array is fabricated by polymer-assisted transfer of graphene on a patterned Ge substrate, and the backgate voltage modulates surface conductivity in GRIN lenses by controlling electric field across the graphene sheet. In methods of operating SAOC, the paraboloid-shaped dielectric achieves continuous and parabolic variation of conductivity and permittivity by applying spatially uniform back-gate voltage. The electric field can be controlled across the graphene sheet to modulate surface conductivity in GRIN lenses by applying backgate voltage. In example, the integrated computing platform includes a control circuit to modulate the backgate voltage and control the surface conductivity in the GRIN lenses, or the MTA array can be configured to perform complex mathematical operations on the incident wave distribution f(x,y).

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity but possibly with one or more additional intervening materials such that contact is possible but not required. Neither “on” nor “over” implies any directionality as used herein. The term “conformal” describes a coating material in which the conformal material preserves the angles of the underlying material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An integrated computing platform for performing spatial analog optical computing on a chip, comprising:
a semiconductor substrate;
a backgate electrode on a bottom side of the semiconductor substrate;
one or more graded index media sections on a top surface of the semiconductor substrate comprising a grooved recess; and
a meta-transmit array (MTA) on a top side of the semiconductor substrate and adjacent to the one or more graded index media sections.

2. The integrated computing platform for performing spatial analog optical computing on a chip of claim 1, wherein the semiconductor substrate comprises germanium.

3. The integrated computing platform for performing spatial analog optical computing on a chip of claim 1, wherein the semiconductor substrate further comprises a dielectric layer disposed in at least a portion of the grooved recess.

4. The integrated computing platform for performing spatial analog optical computing on a chip of claim 3, wherein one or more graded index media sections comprise a graphene layer on the top or front surface of the dielectric layer.

5. The integrated computing platform for performing spatial analog optical computing on a chip of claim 1, wherein the one or more graded index media sections are configured to perform a Fourier transform (FT) of a wave.

6. The integrated computing platform for performing spatial analog optical computing on a chip of claim 1, wherein the one or more graded index media sections further comprise a parabolic profile comprising a plurality of parabolic contours in at least one spatial direction.

7. The integrated computing platform for performing spatial analog optical computing on a chip of claim 1, wherein the MTA further comprises a top surface layer comprising graphene.

8. The integrated computing platform for performing spatial analog optical computing on a chip of claim 1, wherein the backgate electrode on the bottom or back surface of the semiconductor substrate comprises a metal.

9. A method for fabricating a platform for performing spatial analog optical computing on a chip, comprising:
etching a surface of a semiconductor substrate anisotropically to create a plurality of sharp v-shaped grooves in a surface of the semiconductor substrate;
creating a plurality of paraboloid-shaped grooves in the surface of the semiconductor substrate by isotropic etching in water to smooth sharp tips and walls of the v-shaped grooves;
filling the plurality of paraboloid-shaped grooves with a dielectric material; and
transferring a graphene sheet from a growth substrate onto the surface of the semiconductor substrate.

10. The method for fabricating a platform for performing spatial analog optical computing on a chip of claim 9, wherein the semiconductor substrate comprises a (001) germanium.

11. The method for fabricating a platform for performing spatial analog optical computing on a chip of claim 9, wherein the dielectric material comprises a polymer.

12. The method for fabricating a platform for performing spatial analog optical computing on a chip of claim 11, wherein the polymer comprises an epoxy.

13. The method for fabricating a platform for performing spatial analog optical computing on a chip of claim 9, further comprising depositing the dielectric material via spin coating a polymer to fill the plurality of paraboloid-shaped grooves.

14. The method for fabricating a platform for performing spatial analog optical computing on a chip of claim 9, wherein the growth substrate comprises a copper foil.

15. The method for fabricating a platform for performing spatial analog optical computing on a chip of claim 9, further comprising using a polymer-assisted process to transfer the graphene sheet onto the surface of the semiconductor substrate.

16. The method for fabricating a platform for performing spatial analog optical computing on a chip of claim 9, further comprising metalizing a back surface of the Ge substrate by physical vapor deposition to create a backgate electrode.

17. An integrated computing platform, comprising:
a meta-transmit array (MTA) array comprising a patterned germanium substrate;
a graded index (GRIN) lens comprising a parabolic profile on the patterned germanium substrate; and
a backgate electrode on a back side of the patterned germanium substrate.

18. The integrated computing platform of claim 17, wherein the patterned germanium substrate further comprises a dielectric layer disposed into the parabolic profile of the graded index (GRIN) lens.

19. The integrated computing platform of claim 17, wherein the backgate electrode comprises a metal.

20. The integrated computing platform of claim 17, further comprising a control circuit connected to the backgate and configured to control a surface conductivity in the GRIN lenses.
